(19) United States
(12) Patent Application Publication
(10) Pub. No.: US 2015/0261597 A1
(43) Pub. Date: Sep. 17, 2015

(54) SYSTEM AND METHOD FOR STORAGE OF A CORE DUMP ON A REMOTELY CONNECTED STORAGE DEVICE IN A CLUSTER ENVIRONMENT

(71) Applicant: NETAPP, INC., Sunnyvale, CA (US)

(72) Inventors: Venkata Ramprasad Darisa, Andhra Pradesh (IN); Nandakumar Ravindranath Allu, Tamil Nadu (IN)

(73) Assignee: NETAPP, INC., Sunnyvale, CA (US)

(21) Appl. No.: 14/278,165

(22) Filed: May 15, 2014

(30) Foreign Application Priority Data
Mar. 14, 2014 (IN) 764/DEL/2014

(51) Int. Cl. G06F 11/07

(52) U.S. Cl. CPC G06F 11/0778; G06F 11/0787; G06F 11/0727

(57) ABSTRACT

A system and method for storage of a core dump on a remotely connected storage device in a cluster environment is provided. In response to the need to perform a core dump operation, determination is made whether a local storage disk is available. If no local spare disk is available, other nodes in the cluster are queried via a cluster fabric protocol to identify a spare disk connected to another node of the cluster. The core dump is then performed via a cluster fabric switching network from a failed node to a node hosting a free spare disk.

### RELATED APPLICATION

The present application claims priority to commonly owned Indian Patent Application Serial No. 764/DEL/2014, entitled System and Method For Storage Of A Core Dump On A Remotely Connected Storage Device In A Cluster Environment, by Venkata Ramprasad Darisa et al., filed on Mar. 14, 2014, the contents of which are hereby incorporated by reference.

### TECHNICAL FIELD

The present invention relates to clustered storage systems and, more particularly to storing a core dump on a remotely connected storage device in a clustered storage system.

### BACKGROUND INFORMATION

A core dump, which may also be termed a memory dump or system dump, typically comprises of the recorded contents of a computer's memory at a specific time, generally when either a program or the operating system has encountered an error condition and terminated abruptly, i.e. crashed. Other key pieces of the program state are usually dumped concurrently including, for example, processor registers, program counter stack pointer, memory management information and/or other processor and/or operating system flags and information. Core dumps are typically used to assist in diagnosing and debugging errors in computer programs. By analyzing the state of the memory at the time that an error condition occurred, it is often possible to diagnose the cause of the error condition.

When a node executing in a cluster environment encounters an error condition that causes a core dump, the node typically examines the set of spare disks connected to the node to identify a spare disk having sufficient storage space for the core dump. Should a spare disk be identified that has sufficient storage space, the node then performs a core dump operation to the identified spare disk. However, if no spare disks associated connected to the node have sufficient free space, the node will not save the core dump, which may complicate potential diagnosing and/or debugging of the cause of the error condition. Similarly, if no spare disks are connected to the node, the core dump operation will fail and no core dump is saved. Further, no core dump may be saved when an error condition occurs during the initialization of a node prior to its disks being discovered and associated with the node.

### BRIEF DESCRIPTION OF THE DRAWINGS

The above and further advantages of invention may be better understood by referring to the following description in conjunction with the accompanying drawings in which like reference numerals indicate identical or functionally similar elements:

FIG. 1 is a schematic block diagram of a plurality of nodes interconnected as a cluster;

FIG. 2 is a schematic block diagram of a node;

FIG. 3 is a schematic block diagram of an exemplary storage operating system;

FIG. 4 is a schematic block diagram illustrating the format of a cluster fabric (CF) message; and

FIG. 5 is a flow chart detailing the steps of a procedure for remotely storing a core dump.

### DESCRIPTION OF ILLUSTRATIVE EMBODIMENTS

Embodiments of the present invention are directed to a system and method for storage of a core dump on a remotely connected storage device in a cluster environment that illustratively comprises of a plurality of nodes operatively interconnected by a cluster switching fabric for other inter-cluster communication network. Connected to each node are one or more storage devices, such as disks, that may be configured for storage of data and/or may be designated as spare disks to be utilized for core dumps and/or data reconstruction in the event of a failure of a disk configured for data storage. Each node illustratively executes a storage operating system comprising a core dump module configured to manage the creation of core dumps in the event of the storage operating system or other application encountering an error condition.

In an embodiment, when a node suffers an error condition requiring a core dump, the core dump module works to identify whether a spare disk is locally connected that has sufficient space to store the core dump. As used herein, the term locally connected means a disk that is operatively connected to, and primarily managed by, the node. A locally connected disk may have intermediate network devices, such as switches, hubs, routers, etc. between the node and the locally connected disk. Should a locally connected spare disk be available, the core dump module performs a core dump to the locally connected disk before storing the location of the core dump in the event log of the node. The location of the core dump may be retrieved later to identify which disk is storing the core dump. The node may then be rebooted to attempt to correct the error condition. However, if a spare disk that has sufficient space to store the core dump is not locally connected, the core dump module queries the other nodes of the cluster to identify a free spare disk. Such queries may take the form of messages sent via a cluster fabric (CF) protocol over a cluster switching fabric that operatively interconnects the nodes of the cluster. Should no remotely connected spare disk of the identified, the core dump module alerts the administrator of the failure to store the core dump before rebooting the node. The alert may comprise a console message and/or a log entry in the event log associated with the node servicing the spare disk on which the core dump is saved.

However, should a spare disk be identified that is remotely connected to the failed node, the core dump module manages a core dump to the remote spare disk using a cluster switching fabric. Illustratively, the core dump module may transmit the core dump, via CF messages over the cluster switching fabric, to the remote node that manages the selected remote spare disk. Once the core dump has been stored, the node then stores the location of the core dump in an event log of the node servicing the remote spare disk prior to rebooting.

A storage system typically comprises one or more storage devices into which information may be entered, and from which information may be obtained, as desired. The storage system includes a storage operating system that functionally organizes the system by, inter alia, invoking storage operations in support of a storage service implemented by the system. The storage system may be implemented in accordance with a variety of storage architectures including, but not limited to, a network-attached storage environment, a storage area network and a disk assembly directly attached to a client or host computer. The storage devices are typically disk drives organized as a disk array, wherein the term “disk” commonly describes a self-contained rotating magnetic media storage device. The term disk in this context is synonymous with hard disk drive (HDD) or direct access storage device (DASD).

The storage operating system of the storage system may implement a high-level module, such as a file system, to logically organize the information stored on volumes as a hierarchical structure of data containers, such as files and logical units. For example, each “on-disk” file may be implemented as set of data structures, i.e., disk blocks, configured to store information, such as the actual data for the file. These data blocks are organized within a volume block number (vbn) space that is maintained by the file system. The file system may also assign each data block in the file a corresponding “file offset” or file block number (fbn). The file system typically assigns sequences of fbns on a per-file basis, whereas vbns are assigned over a larger volume address space. The file system organizes the data blocks within the vbn space as a “logical volume”; each logical volume may be, although is not necessarily, associated with its own file system.

A known type of file system is a write-anywhere file system that does not overwrite data on disks. If a data block is retrieved (read) from disk into a memory of the storage system and “dirtied” (i.e., updated or modified) with new data, the data block is thereafter stored (written) to a new location on disk to optimize write performance. A write-anywhere file system may initially assume an optimal layout such that the data is substantially contiguously arranged on disks. The optimal disk layout results in efficient access operations, particularly for sequential read operations, directed to the disks. An example of a write-anywhere file system that is configured to operate on a storage system is the Write Anywhere File Layout (WAFL®) file system available from NetApp, Inc., Sunnyvale, Calif.

The storage system may be further configured to operate according to a client/server model of information delivery to thereby allow many clients to access data containers stored on the system. In this model, the client may comprise an application, such as a database application, executing on a computer that “connects” to the storage system over a computer network, such as a point-to-point link, shared local area network (LAN), wide area network (WAN), or virtual private network (VPN) implemented over a public network such as the Internet. Each client may request the services of the storage system by issuing file-based and block-based protocol messages (in the form of packets) to the system over the network.

A. Cluster Environment

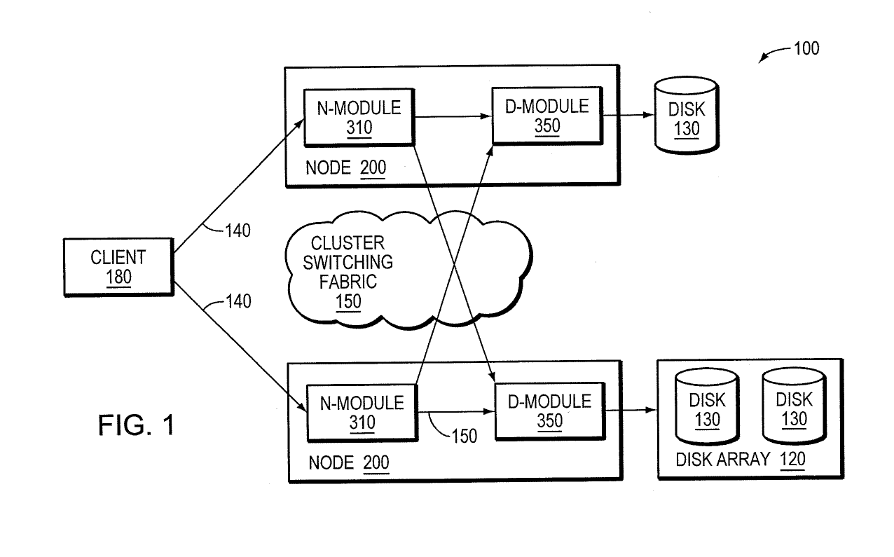

FIG. 1 is a schematic block diagram of a plurality of nodes 200 interconnected as a cluster 100 and configured to provide storage service relating to the organization of information on storage devices. The nodes 200 comprise various functional components that cooperate to provide a distributed storage system architecture of the cluster 100. To that end, each node 200 is generally organized as a network element (N-module 310) and a disk element (D-module 350). The N-module 310 includes functionality that enables the node 200 to connect to clients 180 over a computer network 140, while each D-module 350 connects to one or more storage devices, such as disks 130 of a disk array 120. The disks 130 may be utilized as storage space for the nodes. Further, disks 130 may be spare disks, i.e., currently not assigned for storage. Spare disks may be utilized for replacement of storage disks in the event of a failure or may be utilized to store core dumps in accordance with embodiments of the present invention.

The nodes 200 are interconnected by a cluster switching fabric 150 which, in the illustrative embodiment, may be embodied as a Gigabit Ethernet switch. An exemplary distributed file system architecture is generally described in U.S. Pat. No. 6,671,773 titled METHOD AND SYSTEM FOR RESPONDING TO FILE SYSTEM REQUESTS, by M. Kazar et al. issued Dec. 30, 2003. It should be noted that while there is shown an equal number of N and D-modules in the illustrative cluster 100, there may be differing numbers of N and/or D-modules in accordance with various embodiments of the present invention. For example, there may be a plurality of N-modules and/or D-modules interconnected in a cluster configuration 100 that does not reflect a one-to-one correspondence between the N and D-modules. As such, the description of a node 200 comprising one N-module and one D-module should be taken as illustrative only.

The clients 180 may be general-purpose computers configured to interact with the node 200 in accordance with a client/server model of information delivery. That is, each client may request the services of the node, and the node may return the results of the services requested by the client, by exchanging packets over the network 140. The client may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks.

B. Storage System Node

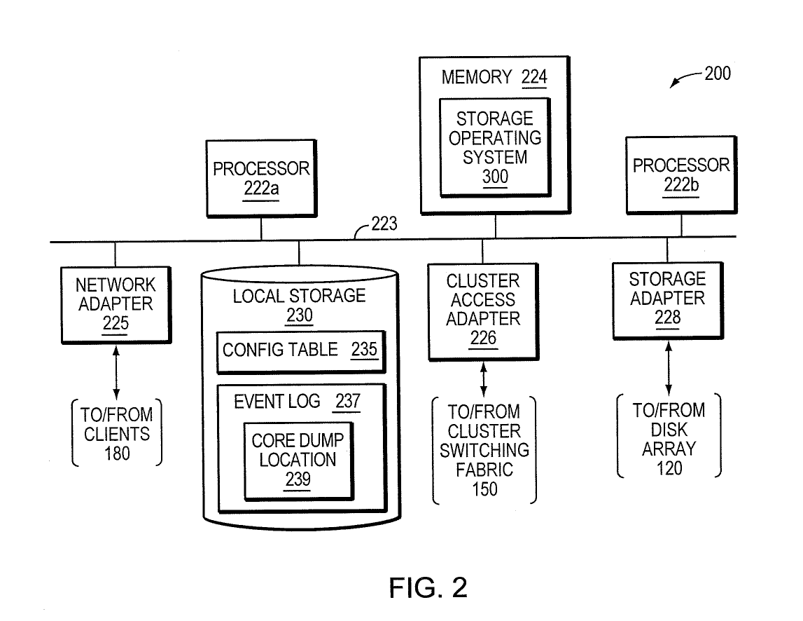

FIG. 2 is a schematic block diagram of a node 200 that is illustratively embodied as a storage system comprising a plurality of processors 222a,b, a memory 224, a network adapter 225, a cluster access adapter 226, a storage adapter 228 and local storage 230 interconnected by a system bus 223. The local storage 230 comprises one or more storage devices, such as disks, utilized by the node to locally store information. Information stored on local storage 230 may comprise a configuration table 235 and/or an event log 237. Configuration table 235 may store various configuration information associated with the node. The event log 237 illustratively stores entries associated with node events. One exemplary type of entry is an entry identifying a core dump location 239. Illustratively, a core dump location entry 239 may identify the disk (or other storage device) within the cluster environment that is storing a particular core dump.

The cluster access adapter 226 comprises a plurality of ports adapted to couple the node 200 to other nodes of the cluster 100. In the illustrative embodiment, Ethernet is used as the clustering protocol and interconnect media, although it will be apparent to those skilled in the art that other types of protocols and interconnects may be utilized within the cluster architecture described herein. In alternate embodiments where the N-modules and D-modules are implemented on separate storage systems or computers, the cluster access adapter 226 is utilized by the N/D-module for communicating with other N/D-modules in the cluster 100.

Each node 200 is illustratively embodied as a dual processor storage system executing a storage operating system 300 that preferably implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor 222a executes the functions of the N-module 310 on the node, while the other processor 222b executes the functions of the D-module 350.

The memory 224 illustratively comprises storage locations that are addressable by the processors and adapters for storing software program code and data structures associated with the present invention. The processor and adapters may, in turn, comprise processing elements and/or logic circuitry configured to execute the software code and manipulate the data structures. The storage operating system 300, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the invention described herein.

The network adapter 225 comprises a plurality of ports adapted to couple the node 200 to one or more clients 180 over point-to-point links, wide area networks, virtual private networks implemented over a public network (Internet) or a shared local area network. The network adapter 225 thus may comprise the mechanical, electrical and signaling circuitry needed to connect the node to the network. Illustratively, the computer network 140 may be embodied as an Ethernet network or a Fibre Channel (FC) network. Each client 180 may communicate with the node over network 140 by exchanging discrete frames or packets of data according to pre-defined protocols, such as TCP/IP.

The storage adapter 228 cooperates with the storage operating system 300 executing on the node 200 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored on the disks 130 of array 120. The storage adapter comprises a plurality of ports having input/output (I/O) interface circuitry that couples to the disks over an I/O interconnect arrangement, such as a conventional high-performance, FC link topology.

Storage of information on each array 120 is preferably implemented as one or more storage “volumes” that comprise a collection of physical storage disks 130 cooperating to define an overall logical arrangement of volume block number (vbn) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

C. Storage Operating System

To facilitate access to the disks 130, the storage operating system 300 implements a write-anywhere file system that cooperates with one or more virtualization modules to “virtualize” the storage space provided by disks 130. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (luns).

In the illustrative embodiment, the storage operating system is preferably the NetApp® Data ONTAP® operating system available from NetApp, Inc., Sunnyvale, Calif. that implements a Write Anywhere File Layout (WAFL®) file system. However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this invention.

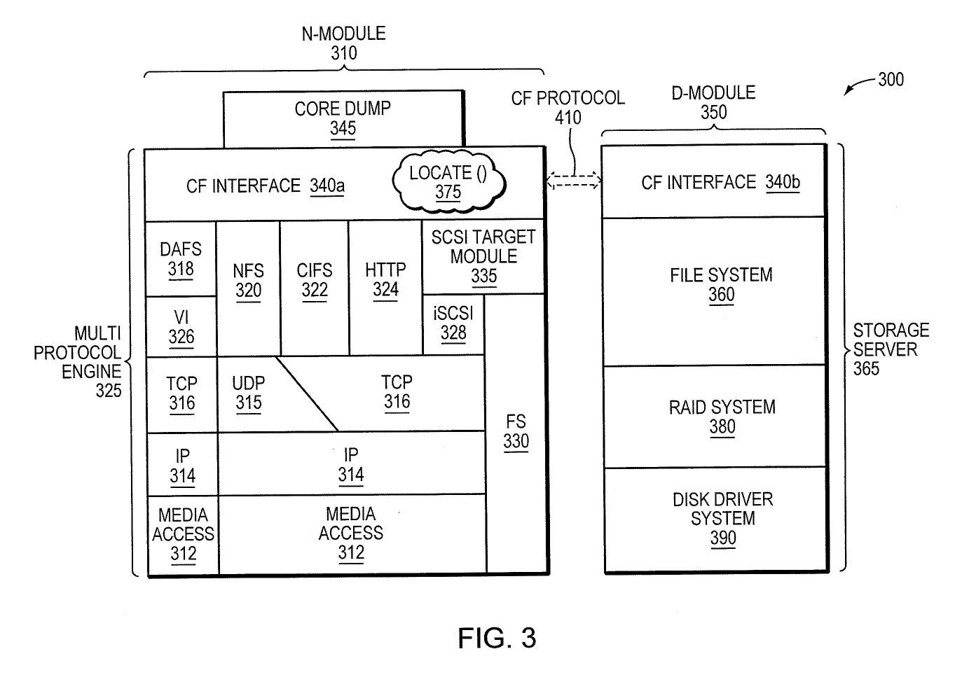

FIG. 3 is a schematic block diagram of the storage operating system 300 that may be advantageously used with the present invention. The storage operating system comprises a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 320, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 330 receives and transmits block access requests and responses to and from the node. The FC and iSCSI drivers provide FC-specific and iSCSI-specific access control to the blocks and, thus, manage exports of luns to either iSCSI or FCP or, alternatively, to both iSCSI and FCP when accessing the blocks on the node 200.

In addition, the storage operating system includes a series of software layers organized to form a storage server 365 that provides data paths for accessing information stored on the disks 130 of the node 200. To that end, the storage server 365 includes a file system module 360, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 implements a virtualization system of the storage operating system 300 through the interaction with one or more virtualization modules illustratively embodied as, e.g., a virtual disk (vdisk) module (not shown) and a SCSI target module 335. The SCSI target module 335 is generally disposed between the FC and iSCSI drivers 328, 330 and the file system 360 to provide a translation layer of the virtualization system between the block (lun) space and the file system space, where luns are represented as blocks.

The file system 360 is illustratively a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 illustratively implements the WAFL file system (hereinafter generally the “write-anywhere file system”) having an on-disk format representation that is block-based using, e.g., 4 kilobyte (KB) blocks and using index nodes (“inodes”) to identify files and file attributes (such as creation time, access permissions, size and block location). The file system uses files to store meta-data describing the layout of its file system; these meta-data files include, among others, an inode file. A file handle, i.e., an identifier that includes an inode number, is used to retrieve an inode from disk.

Broadly stated, all inodes of the write-anywhere file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from the client 180 is forwarded as a packet over the computer network 140 and onto the node 200 where it is received at the network adapter 225. A network driver (of layer 312 or layer 330) processes the packet and, if appropriate, passes it on to a network protocol and file access layer for additional processing prior to forwarding to the write-anywhere file system 360. Here, the file system generates operations to load (retrieve) the requested data from disk 130 if it is not resident “in core”, i.e., in memory 224. If the information is not in memory, the file system 360 indexes into the inode file using the inode number to access an appropriate entry and retrieve a logical vbn. The file system then passes a message structure including the logical vbn to the RAID system 380; the logical vbn is mapped to a disk identifier and disk block number (disk,dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

It should be noted that the software “path” through the storage operating system layers described above needed to perform data storage access for the client request received at the node may alternatively be implemented in hardware. That is, in an alternate embodiment of the invention, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Moreover, in another alternate embodiment of the invention, the processing elements of adapters 225, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node 200, implement data access semantics of a general purpose operating system. The storage operating system can also be implemented as a microkernel, an application program operating over a general-purpose operating system, such as UNIX® or Windows NT®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present invention may be utilized with any suitable file system, including a write in place file system.

A core dump module 345 is operatively interconnected with the CF interface 340. The core dump module 345 illustratively manages the creation of core dumps in accordance with an illustrative embodiment of the present invention. More generally, the core dump module 345 manages the creation of cored dumps either locally or on remote storage devices, e.g., disks. It should be noted that the core dump module is shown atop of the CF interface 340 for illustrative purposes. In accordance with alternative embodiments of the present invention, the core dump module 345 made be located elsewhere within the storage operating system. As such, the description of the core dump module 345 being located atop of the CF interface should be taken as exemplary only.

D. CF Protocol

In the illustrative embodiment, the storage server 365 is embodied as D-module 350 of the storage operating system 300 to service one or more volumes of array 120. In addition, the multi-protocol engine 325 is embodied as N-module 310 to (i) perform protocol termination with respect to a client issuing incoming data access request packets over the network 140, as well as (ii) redirect those data access requests to any storage server 365 of the cluster 100. Moreover, the N-module 310 and D-module 350 cooperate to provide a highly-scalable, distributed storage system architecture of the cluster 100. To that end, each module includes a cluster fabric (CF) interface module 340a,b adapted to implement intra-cluster communication among the modules, including D-module-to-D-module communication for data container striping operations described herein.

The protocol layers, e.g., the NFS/CIFS layers and the iSCSI/FC layers, of the N-module 310 function as protocol servers that translate file-based and block based data access requests from clients into CF protocol messages used for communication with the D-module 350. That is, the N-module servers convert the incoming data access requests into file system primitive operations (commands) that are embedded within CF messages by the CF interface module 340 for transmission to the D-modules 350 of the cluster 100. Notably, the CF interface modules 340 cooperate to provide a single file system image across all D-modules 350 in the cluster 100. Thus, any network port of an N-module that receives a client request can access any data container within the single file system image located on any D-module 350 of the cluster.

Further to the illustrative embodiment, the N-module 310 and D-module 350 are implemented as separately-scheduled processes of storage operating system 300; however, in an alternate embodiment, the modules may be implemented as pieces of code within a single operating system process. Communication between an N-module and D-module is thus illustratively effected through the use of message passing between the modules although, in the case of remote communication between an N-module and D-module of different nodes, such message passing occurs over the cluster switching fabric 150. A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc. The SpinFS protocol is described in the above-referenced U.S. Pat. No. 6,671,773. The CF interface module 340 implements the CF protocol for communicating file system commands among the modules of cluster 100. Communication is illustratively effected by the D-module exposing the CF API to which an N-module (or another D-module) issues calls. To that end, the CF interface module 340 is organized as a CF encoder and CF decoder. The CF encoder of, e.g., CF interface 340a on N-module 310 encapsulates a CF message as (i) a local procedure call (LPC) when communicating a file system command to a D-module 350 residing on the same node 200 or (ii) a remote procedure call (RPC) when communicating the command to a D-module residing on a remote node of the cluster 100. In either case, the CF decoder of CF interface 340b on D-module 350 de-encapsulates the CF message and processes the file system command.

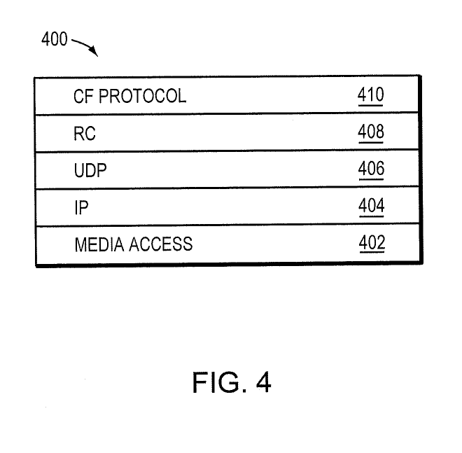

FIG. 4 is a schematic block diagram illustrating the format of a CF message 400 in accordance with an embodiment of with the present invention. The CF message 400 is illustratively used for RPC communication over the switching fabric 150 between remote modules of the cluster 100; however, it should be understood that the term “CF message” may be used generally to refer to LPC and RPC communication between modules of the cluster. The CF message 400 includes a media access layer 402, an IP layer 404, a UDP layer 406, a reliable connection (RC) layer 408 and a CF protocol layer 410. As noted, the CF protocol is a generic file system protocol that conveys file system commands related to operations contained within client requests to access data containers stored on the cluster 100; the CF protocol layer 410 is that portion of message 400 that carries the file system commands. Illustratively, the CF protocol is datagram based and, as such, involves transmission of messages or “envelopes” in a reliable manner from a source (e.g., an N-module 310) to a destination (e.g., a D-module 350). The RC layer 408 implements a reliable transport protocol that is adapted to process such envelopes in accordance with a connectionless protocol, such as UDP 406.

E. Identifying a Disk to Store a Core Dump

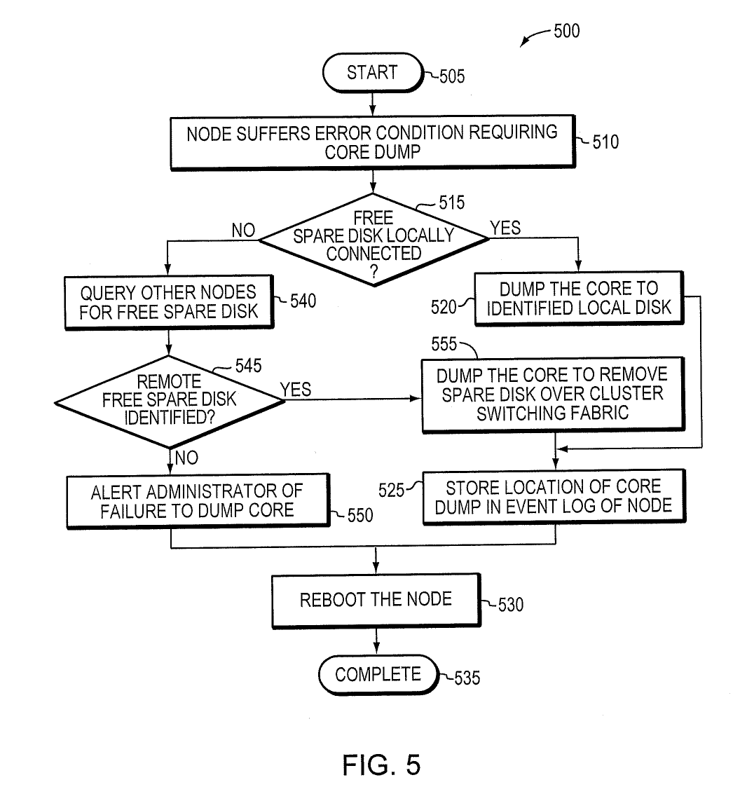

FIG. 5 is a flowchart detailing the steps of a procedure 500 for remotely storing a core dump. The procedure 500 begins in step 505 continues to step 510 where a node suffers an error condition requiring a core dump. As will be appreciated by those skilled in the art, not every error condition that occurs may result in a core dump. Certain error conditions may be recoverable without requiring a reboot of the storage operating system executing on the node. The severity of the error condition requiring a core dump may vary with particular embodiments. In response to the node suffering an error condition that requires a core dump, the core dump module determines whether there is a spare disk that is locally attached to the node in step 515. Illustratively, the core dump module queries the attached disks to determine whether any spare disks are directly connected to the node. Further, if there are spare disks directly connected to the node, the core dump module will determine whether the locally connected disks have sufficient storage space for the core dump.

Should the core dump module identify a free spare disk that is locally connected, the procedure branches to step 520 where the core dump module executes a core dump the identified local disk. This core dump may be performed as a conventional core dump to the locally connected disk. Once the core has been written to the local disk, the procedure continues to step 525 where the core dump module stores the location of the core dump in an event log of the node. Illustratively, the core dump module may store a core dump location entry 239 within the event log 237. As will be appreciated by those skilled in the art, the format of the event log 237 and core dump location entry 239 may vary depending upon the particular architectures involved with a node. As such, the descriptions contained herein of the event log 237 and core dump location entry 239 should be taken as exemplary only. Once the location of the core dump has been stored, the node is then rebooted in step 530. The procedure 500 then completes in step 535.

If, in step 515, it is determined that no free spare disk is locally connected, the procedure branches to step 540 where the core dump module queries other nodes in an attempt to identify a free spare disk. Such queries may be made by passing CF messages over the cluster switching fabric to the other nodes. A determination is made in step 545 whether any remote spare disks have been identified. If a remote node is identified as having an appropriate spare disk, the procedure branches to step 555 where the core dump module causes the core dump to be written to the remotely connected spare disk. This core dump is illustratively performed by transmitting the core dump data over the cluster switching fabric to the remote node, which then manages the writing of the core dump to the identified disk. Once the core dump has been written, the procedure then continues to step 525 and stores the location of the core dump in the event log of the local node. The procedure 500 then continues to step 530 where the node is rebooted. The procedure 500 then completes in step 535.

However, if in step 545, it is determined that no remote spare disks are available, the procedure branches to step 550 where the core dump module alerts the administrator of a failure to perform a core dump. This notification may be accomplished by, e.g., writing a message to a management console (not shown), storing an entry in the event log, etc. As will be appreciated by those skilled in the art, a plurality of techniques may be used to provide alerts to an administrator. As such, those described herein should be taken as exemplary only. The node is then rebooted in step 530 before the procedure 500 completes in step 535.

The foregoing description has been directed to particular embodiments of this invention. It will be apparent, however, that other variations and modifications may be made to the described embodiments, with the attainment of some or all of their advantages. Specifically, it should be noted that the principles of the present invention may be implemented in non-distributed file systems. Furthermore, while this description has been written in terms of N and D-modules, the teachings of the present invention are equally suitable to systems where the functionality of the N and D-modules are implemented in a single system. Alternately, the functions of the N and D-modules may be distributed among any number of separate systems, wherein each system performs one or more of the functions. Additionally, the procedures, processes and/or modules described herein may be implemented in hardware, software, embodied as a computer-readable medium having program instructions, firmware, or a combination thereof. Therefore, it is the object of the appended claims to cover all such variations and modifications as come within the true spirit and scope of the invention.

What is claimed is:

1. The method comprising:
determining whether at least one locally connected spare data container is available to support a core dump;
in response to determining that at least one locally connected spare data container is not available to support a core dump:
querying one or more nodes of a cluster to identify one or more remotely connected spare data containers;
selecting one of the one or more remotely connected spare data containers; and
performing a core dump operation to the selected remotely connected spare data container, wherein core dump information is transmitted to the remotely connected spare data container via a cluster switching fabric.

2. The method of claim 1 further comprising storing a location of the core dump in a core dump entry in an event log.

3. The method of claim 2 further comprising rebooting a node.

4. The method of claim 1 further comprising:
in response to determining that at least one locally connected spare data container is available to support the core dump, storing the core dump on the at least one locally connected spare data container.

5. The method of claim 4 further comprising storing a location of the core dump in a core dump entry in an event log.

6. The method of claim 5 further comprising rebooting a node.

7. A system comprising:
a local node operatively interconnected with one or more local disks, the local node further operatively interconnected with one or more remote nodes organized as a cluster, the local node executing a storage operating system, the storage operating system comprising a core dump module; and
wherein the core dump module is configured to query the one or more remote nodes to determine whether at least one of the one or more remote nodes has at least one remotely connected spare disk available, the core dump module further configured to perform a core dump operation to a selected one of the at least one remotely connected spare disks.

8. The system of claim 7 wherein the local node and the one or more remote nodes are operatively interconnected by a switching fabric.

9. The system of claim 7 wherein the core dump module queries the one or more remote nodes by transmitting cluster fabric messages via a network operatively interconnecting the local node and the one or more remote nodes.

10. The system of claim 7 wherein the core dump operation transmits core dump information via a network one of the one or more remote nodes managing the selected one of the at least one remotely connected spare disks.

11. The system of claim 7 wherein the core dump module is further configured to store location information.

12. The system of claim 11 wherein the location information is stored in a core dump entry of an event log.

13. The system of claim 12 wherein the event log is stored on a storage device associated with the local node.

14. The system of claim 7 wherein the core dump module is further configured to reboot the local node after performing the core dump procedure.

15. A non-transitory computer readable medium including program instructions, the program instructions when executed on a processor, causing the process to:
detect that an error condition has occurred;
query one or more nodes of a cluster to identify one or more remotely connected spare data containers;
select one of the one or more remotely connected spare data containers; and
perform a core dump operation to the selected remotely connected spare data container, wherein core dump information is transmitted to the remotely connected spare data container via a cluster switching fabric.
